(19) United States
(12) Patent Application Publication
(10) Pub. No.: US 2026/0139664 A1
(43) Pub. Date: May 21, 2026

(54) INFLATION PUMP AND SOFT START CIRCUIT FOR INFLATION PUMP MOTOR

(71) Applicant: Jingcong Liu, Heyuan (CN)

(72) Inventor: Jingcong Liu, Heyuan (CN)

(21) Appl. No.: 19/411,167

(22) Filed: Dec. 5, 2025

Related U.S. Application Data
(63) Continuation-in-part of application No. 18/950,784, filed on Nov. 18, 2024.

(51) Int. Cl. F04B 49/02; H02P 1/02; H02P 1/16

(52) U.S. Cl. CPC F04B 49/02; H02P 1/027; H02P 1/16

(57) ABSTRACT

Provided here is a soft start circuit for an inflation pump motor, including a control module, a motor drive module, an air pressure detection module, and a voltage detection module. The control module outputs a first control signal to the motor drive module to drive a motor. The control module dynamically adjusts a duty cycle of the first control signal based on real-time feedback of a load air volume and a voltage, gradually increasing motor current to a rated operating current. This PWM-based voltage ramp soft start method allows a motor terminal voltage to rise gradually and smoothly from zero instead of directly applying a full voltage. The above structure solves a technical problem that the inflation pump cannot start due to an excessive inrush current causing power supply protection, and reduces a burden on a power supply.

### CROSS-REFERENCE TO RELATED APPLICATIONS

This application is a continuation in part of U.S. application Ser. No.18/950,784, filed on Nov. 18, 2024, the content of which is incorporated by reference herein.

### TECHNICAL FIELD

The present disclosure relates to the technical field of inflation pump startup, and in particular to a soft start circuit for an inflation pump motor as well as an inflation pump.

### BACKGROUND

As a common power tool, an inflation pump typically uses a DC motor as its core power source. Currently, inflation pumps available on the market generally adopt a direct-start method, and the direct-start method involves applying full voltage directly across both ends of the motor upon power connection, causing the motor to reach maximum speed instantaneously. The direct-start method offers a simple circuit structure and low cost but also exhibits several significant drawbacks.

The first drawback is excessive inrush current. At the moment of startup, when the DC motor is stationary, the counter-electromotive force is zero and the armature resistance is very small. This condition results in an inrush current that can reach 5 to 10 times the rated current.

The second drawback is the impact of mechanical stress. The instantaneous application of high torque during direct start subjects mechanical transmission components, such as the piston and connecting rod, to severe impact. Long-term use accelerates mechanical wear, reduces the service life of the pump, and generates significant startup noise.

The third drawback is poor user experience. The direct startup is accompanied by a loud, sharp “burst” sound and violent vibration, delivering an unfavorable sensory experience to the user.

### SUMMARY

To overcome the deficiencies in the prior art, the present disclosure provides a soft start circuit for an inflation pump motor.

The soft start circuit includes a control module, a motor drive module, an air pressure detection module, and a voltage detection module. The control module is connected to the motor drive module, the air pressure detection module, and the voltage detection module.

The control module outputs a first control signal to the motor drive module, and the motor drive module drives a motor. The air pressure detection module is configured to detect a load air volume in real time and feed back the load air volume to the control module. The voltage detection module is configured to detect a voltage in real time and feed back the voltage to the control module. The control module is configured to dynamically adjust a duty cycle of the first control signal according to an air pressure value fed back by the air pressure detection module and a voltage value fed back by the voltage detection module, so as to increase a current of the motor to a rated operating current.

In an implementation of the present disclosure, the soft start circuit further includes a power input module. An external power supply is input to the control module through the power input module. The power input module includes a first plug interface. The external power supply is connected to the first plug interface. The first plug interface is configured for charging or direct power supply. A first pin of the first plug interface is connected to an anode of the external power supply, and a second pin of the first plug interface is connected to a cathode of the external power supply.

In an implementation of the present disclosure, the power input module further includes a voltage stabilizing circuit configured to stabilize an input voltage of the power input module to 3.3V and supply power to the control module. The voltage stabilizing circuit includes a first voltage stabilizing diode and a voltage stabilizing chip. An anode of the first voltage stabilizing diode is connected to the first pin of the first plug interface. A cathode of the first voltage stabilizing diode is connected to an input pin of the voltage stabilizing chip. An output pin of the voltage stabilizing chip is connected to a fourth pin of the control module. The fourth pin of the control module is connected to a first capacitor and is grounded. The external power supply outputs an initial voltage to the voltage stabilizing chip. The voltage stabilizing chip stabilizes the initial voltage and outputs the stabilized voltage to the control module.

In an implementation of the present disclosure, the power input module further includes a first capacitor part and a second capacitor part, both configured to filter and decouple the input voltage of the power input module. The first capacitor part includes a fifth capacitor, a sixth capacitor, and a seventh capacitor. The fifth capacitor, the sixth capacitor and the seventh capacitor are connected in parallel. A first end of the fifth capacitor is connected between the cathode of the first voltage stabilizing diode and the input pin of the voltage stabilizing chip, and a second end of the fifth capacitor is grounded. A first end of the sixth capacitor is connected between the cathode of the first voltage stabilizing diode and the input pin of the voltage stabilizing chip, and a second end of the sixth capacitor is grounded. A first end of the seventh capacitor is connected between the cathode of the first voltage stabilizing diode and the input pin of the voltage stabilizing chip, and a second end of the seventh capacitor is grounded.

In an implementation of the present disclosure, the second capacitor part includes an eleventh capacitor, a ninth capacitor, and a tenth capacitor. The eleventh capacitor, the ninth capacitor and the tenth capacitor are connected in parallel. A first end of the eleventh capacitor is connected between the output pin of the voltage stabilizing chip and the fourth pin of the control module, and a second end of the eleventh capacitor is grounded. A first end of the ninth capacitor is connected between the output pin of the voltage stabilizing chip and the fourth pin of the control module, and a second end of the ninth capacitor is grounded. A first end of the tenth capacitor is connected between the output pin of the voltage stabilizing chip and the fourth pin of the control module, and a second end of the tenth capacitor is grounded.

In an implementation of the present disclosure, the air pressure detection module includes a third plug interface connected to a differential air pressure sensor. The differential air pressure sensor is configured to detect the load air volume in real time.

In an implementation of the present disclosure, a first pin of the third plug interface is connected to a fifth pin of the control module, a second pin of the third plug interface is connected to a sixth pin of the control module, a third pin of the third plug interface is connected to a seventh pin of the control module, and a fourth pin of the third plug interface is connected to an eighth pin of the control module.

In an implementation of the present disclosure, the voltage detection module includes a fourth resistor, a tenth resistor, and a thirteenth capacitor. A first end of the fourth resistor is connected between the first pin of the first plug interface and the anode of the first voltage stabilizing diode, and a second end of the fourth resistor is connected to the tenth resistor and a ninth pin of the control module, respectively. A first end of the tenth resistor is connected to the fourth resistor, and a second end of the tenth resistor is grounded. A first end of the thirteenth capacitor is connected between the fourth resistor and the ninth pin of the control module, and a second end of the thirteenth capacitor is grounded.

In an implementation of the present disclosure, the control module includes a Microcontroller Unit (MCU) and a pulse width modulation (PWM) generation module. The MCU is configured to receive a start signal and control the PWM generation module to output a PWM signal with a duty cycle starting from a non-zero value and gradually increasing according to a predetermined slope. The PWM signal is amplified by the motor drive module and then drives the motor. The first control signal is the PWM signal.

In an implementation of the present disclosure, the motor drive module includes a first drive part, a second drive part, and a third drive part. The first drive part is configured to receive a power signal from the power input module and a control signal from the control module to form a drive pulse signal, and the drive pulse signal is then fed to the second drive part. The second drive part is configured to receive the drive pulse signal from the first drive part and drive the motor. The third drive part is an enable control part for the motor.

In an implementation of the present disclosure, the first drive part includes an eleventh field effect transistor and a twelfth transistor. A source electrode of the eleventh field effect transistor is connected between the first voltage stabilizing diode and the input pin of the voltage stabilizing chip. A collector electrode of the twelfth transistor is connected to the source electrode of the eleventh field effect transistor through a sixty-third resistor and a sixty-fourth resistor. A gate electrode of the eleventh field effect transistor is connected between the sixty-third resistor and the sixty-fourth resistor.

In an implementation of the present disclosure, the first drive part further includes a sixty-sixth capacitor and a sixty-fifth capacitor. A first end of the sixty-sixth capacitor is connected to a base electrode of the twelfth transistor, and a second end of the sixty-sixth capacitor is connected to a tenth pin of the control module. An emitter electrode of the twelfth transistor is grounded. A first end of the sixty-fifth capacitor is connected between the sixty-sixth capacitor and the base electrode of the twelfth transistor, and a second end of the sixty-fifth capacitor is connected to the emitter electrode of the twelfth transistor and is grounded.

In an implementation of the present disclosure, the second drive part includes a ninth chip, a first field effect transistor, a twentieth capacitor, a twenty-first capacitor and a first resistor. A third pin of the ninth chip is connected to a gate electrode of the first field effect transistor through a sixty-seventh resistor. A drain electrode of the eleventh field effect transistor is connected to a first pin of the ninth chip. The twentieth capacitor and the twenty-first capacitor are connected in parallel. A first end of the twentieth capacitor is connected to the first pin of the ninth chip, and a second end of the twentieth capacitor is connected to a fourth pin of the ninth chip and is grounded. A first end of the twenty-first capacitor is connected between the first pin of the ninth chip and the twentieth capacitor, and a second end of the twenty-first capacitor is connected between the fourth pin of the ninth chip and the twentieth capacitor and is grounded. A first end of the first resistor is connected to a fifth pin of the ninth chip, and a second end of the first resistor is connected to a first pin of the control module.

In an implementation of the present disclosure, the second drive part further includes a second plug interface and a second voltage stabilizing diode. A cathode of the second voltage stabilizing diode is connected between the first pin of the first plug interface and the anode of the first voltage stabilizing diode. An anode of the second voltage stabilizing diode is connected to the gate electrode of the first field effect transistor. A first pin of the second plug interface is connected to the cathode of the second voltage stabilizing diode, and a second pin of the second plug interface is connected between the anode of the second voltage stabilizing diode and a drain electrode of the first field effect transistor.

In an implementation of the present disclosure, the second drive part further includes a sixty-eighth resistor and a seventh resistor. A first end of the seventh resistor is connected to a source electrode of the first field effect transistor, and a second end of the seventh resistor is grounded. A first end of the sixty-eighth resistor is connected between the gate electrode of the first field effect transistor and the sixty-seventh resistor, and a second end of the sixty-eighth resistor is grounded.

In an implementation of the present disclosure, the third drive part includes a fifth transistor, a thirteenth resistor, and a fifteenth resistor. A first end of the thirteenth resistor is connected to a base electrode of the fifth transistor, and a second end of the thirteenth resistor is connected to a second pin of the control module. A first end of the fifteenth resistor is connected between the thirteenth resistor and the base electrode of the fifth transistor, and a second end of the fifteenth resistor is connected to an emitter electrode of the fifth transistor and is grounded. The emitter electrode of the fifth transistor is grounded.

In an implementation of the present disclosure, the third drive part further includes a first motor interface, a fifth resistor, and a sixth resistor. A first pin of the first motor interface is connected between the first pin of the first plug interface and the anode of the first voltage stabilizing diode, and a second pin of the first motor interface is connected to the fifth resistor and the sixth resistor respectively. The fifth resistor and the sixth resistor are connected in parallel. A collector electrode of the fifth transistor is connected to the fifth resistor and the sixth resistor respectively.

In an implementation of the present disclosure, the control module further includes an analog-to-digital conversion module. The analog-to-digital conversion module is configured to receive a load air volume detected in real time by the differential air pressure sensor and convert the load air volume into a real-time air pressure value by using a filtering algorithm. The analog-to-digital conversion module is configured to receive a voltage detected in real time by the voltage detection module and convert the voltage into a real-time voltage value by using the filtering algorithm.

The present disclosure further provides an inflation pump. The inflation pump includes the soft start circuit as described above.

In an implementation of the present disclosure, the inflation pump includes a main body, a control module, a pump body, a battery, a stepless adjustment member, and a selector switch. The control module, the pump body, the battery, the stepless adjustment member, and the selector switch are arranged on the main body. The control module is electrically connected to the battery, the pump body, the stepless adjustment member, and the selector switch, respectively.

A plurality of inflation types with different power ranges for driving the pump body to work are preset within the control module. The selector switch is configured to be operated by a user and to transmit a switching signal to the control module. The stepless adjustment member is configured to be operated by a user and to transmit a stepless adjustment signal to the control module.

The control module is configured to switch an inflation type according to the switching signal and output preset power corresponding to the inflation type to the pump body. The control module is further configured to adjust driving power output to the pump body within a power range of a corresponding inflation type according to the stepless adjustment signal.

Beneficial effects of the present disclosure are as follows: the present disclosure provides a soft start circuit for an inflation pump motor, including a control module, a motor drive module, an air pressure detection module, and a voltage detection module. The control module is connected to the motor drive module, the air pressure detection module, and the voltage detection module, respectively. The control module outputs a first control signal to the motor drive module, and the motor drive module drives a motor. The air pressure detection module is configured to detect a load air volume in real time and feed back the load air volume to the control module. The voltage detection module is configured to detect a voltage in real time and feed back the voltage to the control module. The control module is configured to dynamically adjust a duty cycle of the first control signal according to an air pressure value fed back by the air pressure detection module and a voltage value fed back by the voltage detection module, so as to increase a current of the motor to a rated operating current. A PWM-based voltage ramp soft start method is adopted, so that a motor terminal voltage gradually and smoothly increases from zero instead of directly applying a full voltage, thereby limiting a starting inrush current to within 1.5 times a rated current. The above structure solves a technical problem that the inflation pump cannot start due to an excessive inrush current causing power supply protection, and reduces a burden on a power supply.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a block diagram of Embodiment 1 of the present disclosure;

FIG. 2 is a flowchart of Embodiment 1 of the present disclosure;

FIG. 3 is a flow step diagram of Embodiment 1 of the present disclosure;

FIG. 4 is an MCU circuit diagram of Embodiment 1 of the present disclosure;

FIG. 5 is a circuit diagram of a power input module and of a first drive part of a motor drive module of Embodiment 1 of the present disclosure;

FIG. 6 is a circuit diagram of an air pressure detection module of Embodiment 1 of the present disclosure;

FIG. 7 is a circuit diagram of a second drive part of the motor drive module of Embodiment 1 of the present disclosure;

FIG. 8 is a circuit diagram of a voltage detection module of Embodiment 1 of the present disclosure;

FIG. 9 is a circuit diagram of a third drive part of the motor drive module of Embodiment 1 of the present disclosure;

FIG. 10 is a perspective view of Embodiment 2 of the present disclosure;

FIG. 11 is a structural diagram of a pressing member of Embodiment 2 of the present disclosure;

FIG. 12 is a partial exploded view of Embodiment 2 of the present disclosure;

FIG. 13 is a partial exploded view of Embodiment 2 of the present disclosure with an outer cover removed;

FIG. 14 is a structural diagram of a position limiting cover of Embodiment 2 of the present disclosure;

FIG. 15 is an exploded view of Embodiment 2 of the present disclosure with the outer cover, the position limiting cover, and the pressing member removed;

FIG. 16 is a circuit block diagram of Embodiment 2 of the present disclosure;

FIG. 17 is a circuit diagram of a power adjustment unit of Embodiment 2 of the present disclosure, electrically connected to an MCU and to a battery.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

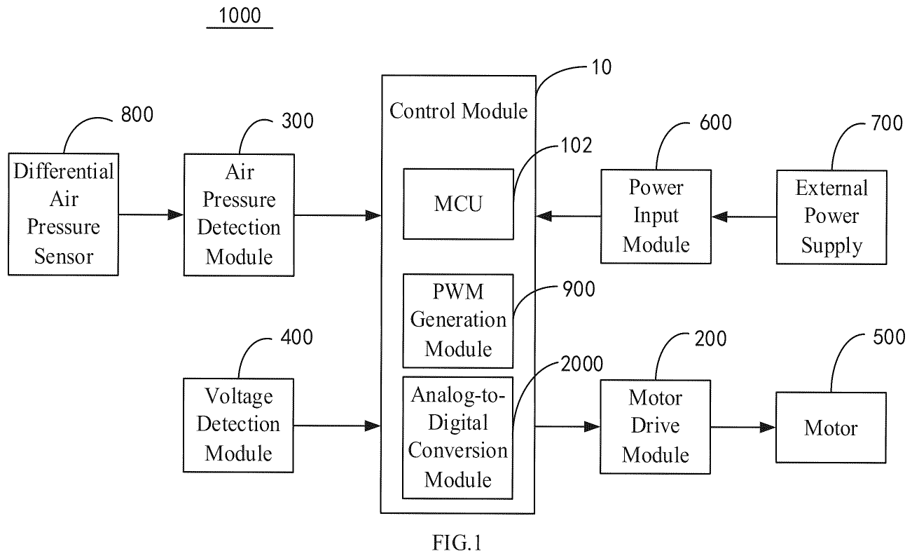

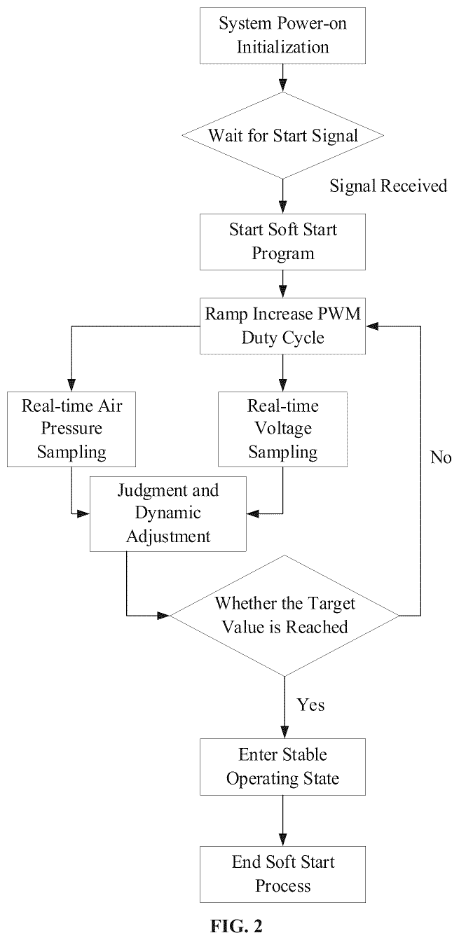

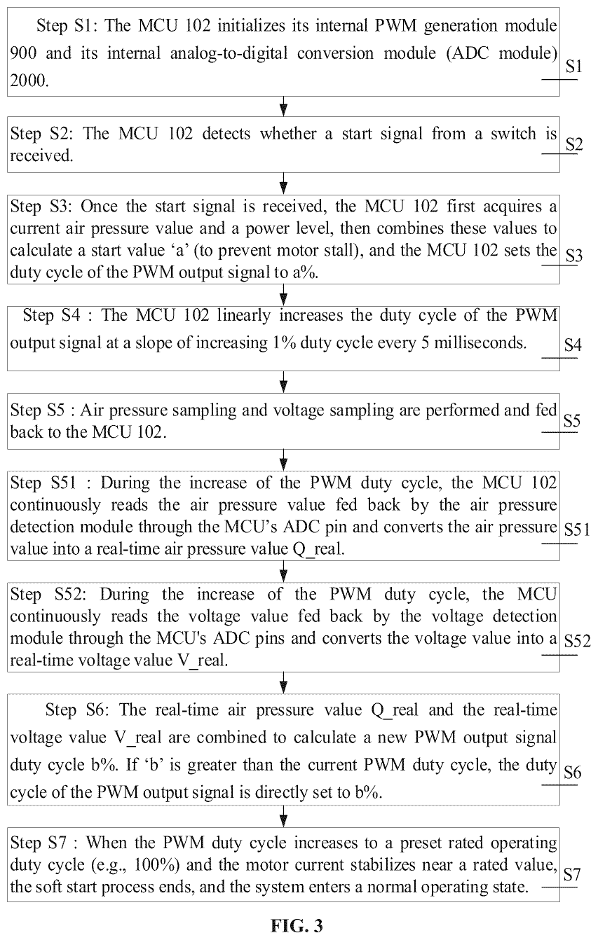

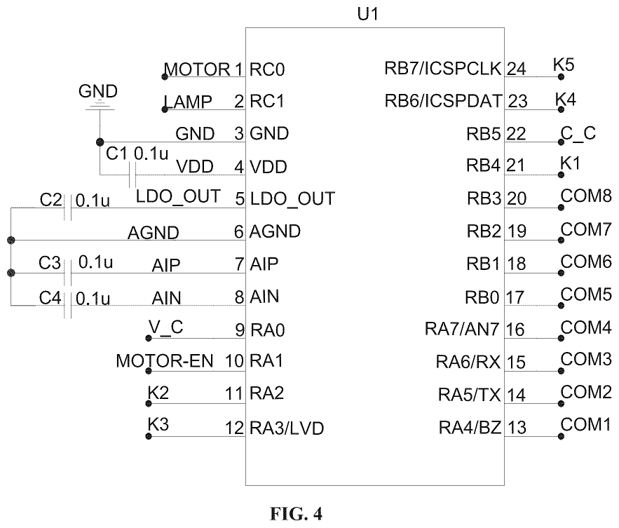

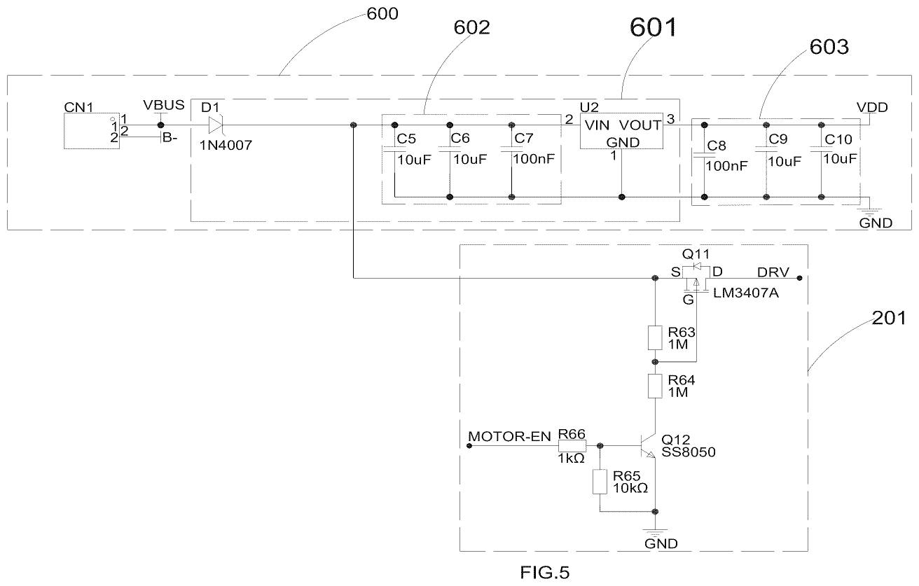

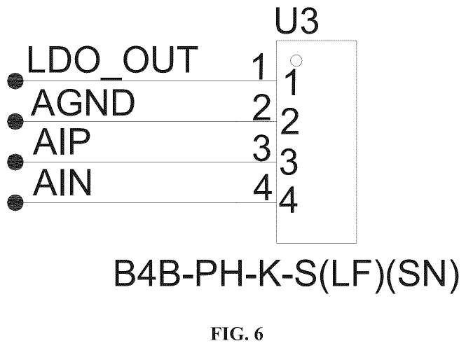

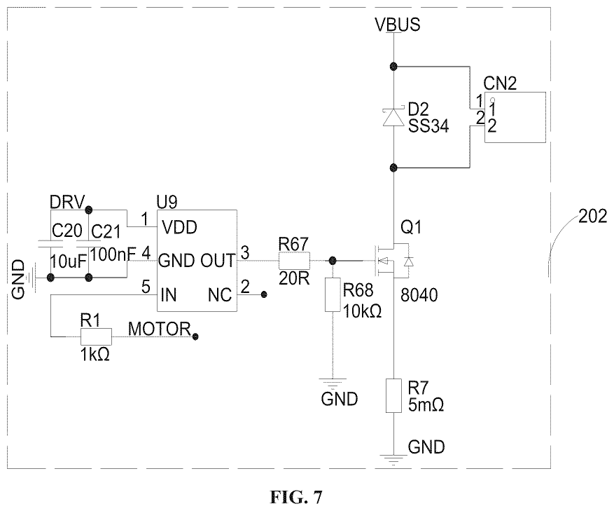

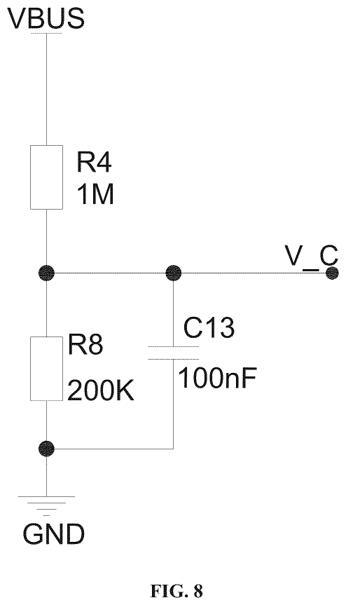

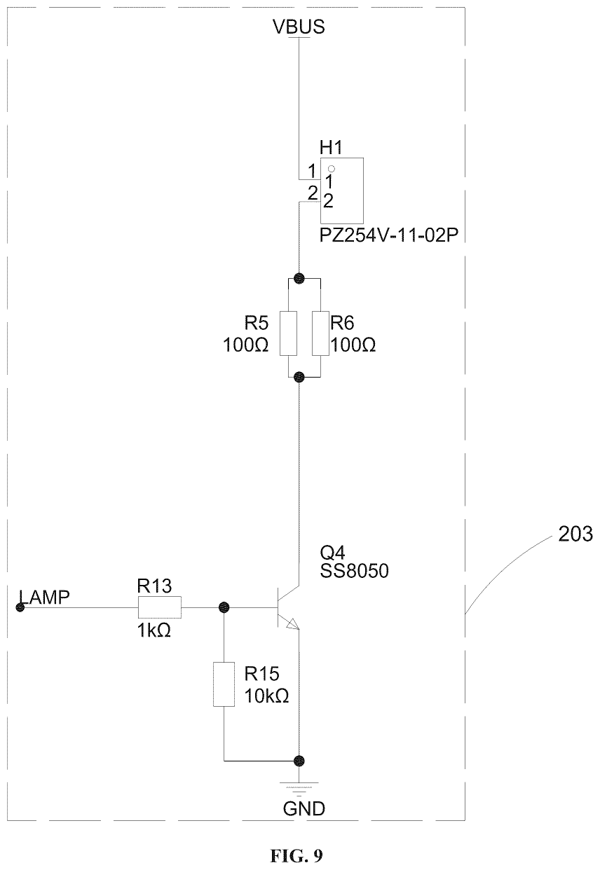

Embodiment 1: With reference to FIG. 1 to FIG. 9, a soft start circuit for an inflation pump motor 1000 includes a control module 10, a motor drive module 200, an air pressure detection module 300, and a voltage detection module 400. The control module 10 is connected to the motor drive module 200, the air pressure detection module 300, and the voltage detection module 400, respectively. The control module 10 outputs a first control signal to the motor drive module 200, and the motor drive module 200 drives a motor 500. The air pressure detection module 300 detects a load air volume in real time and feeds back the load air volume to the control module 10. The voltage detection module 400 detects a voltage in real time and feeds back the voltage to the control module 10. The control module 10 dynamically adjusts a duty cycle of the first control signal according to an air pressure value fed back by the air pressure detection module 300 and a voltage value fed back by the voltage detection module 400, so as to increase a current of the motor 500 to a rated operating current. With the above structure, based on a PWM-based voltage ramp soft start method, a motor terminal voltage gradually and smoothly increases from zero instead of directly applying a full voltage, thereby limiting a starting inrush current to within 1.5 times a rated current. The above structure solves a technical problem that the inflation pump cannot start due to an excessive inrush current causing power supply protection, and reduces a burden on a power supply.

In this embodiment, the soft start circuit 1000 further includes a power input module 600. An external power supply 700 is input to the control module 10 through the power input module 600. The power input module 600 includes a first plug interface CN1. The external power supply 700 is connected to the first plug interface CN1. The first plug interface CN1 is used for charging or direct power supply. A first pin of the first plug interface CN1 is connected to a positive electrode of the external power supply 700. A second pin of the first plug interface CN1 is connected to a negative electrode of the external power supply 700.

In this embodiment, the power input module 600 further includes a voltage stabilizing circuit 601. The voltage stabilizing circuit 601 stabilizes an input voltage of the power input module 600 to 3.3V and supplies power to the control module 10. The voltage stabilizing circuit 601 includes a first voltage stabilizing diode D1 and a voltage stabilizing chip U2. An anode of the first voltage stabilizing diode D1 is connected to the first pin of the first plug interface CN1. A cathode of the first voltage stabilizing diode D1 is connected to an input pin (VIN pin) of the voltage stabilizing chip U2. An output pin (VOUT pin) of the voltage stabilizing chip U2 is connected to a fourth pin (VDD pin) of the control module 10. The fourth pin (VDD pin) of the control module 10 is connected to a first capacitor C1 and is grounded. The external power supply 700 outputs an initial voltage to the voltage stabilizing chip U2. The voltage stabilizing chip U2 stabilizes the initial voltage and outputs the stabilized voltage to the control module 10.

In this embodiment, the power input module 600 further includes a first capacitor part 602 and a second capacitor part 603. The first capacitor part 602 and the second capacitor part 603 both filter and decouple the input voltage of the power input module 600. The first capacitor part 602 includes a fifth capacitor C5, a sixth capacitor C6, and a seventh capacitor C7. The fifth capacitor C5, the sixth capacitor C6, and the seventh capacitor C7 are connected in parallel. A first end of the fifth capacitor C5 is connected between the cathode of the first voltage stabilizing diode D1 and the input pin (VIN pin) of the voltage stabilizing chip U2. A second end of the fifth capacitor C5 is grounded. A first end of the sixth capacitor C6 is connected between the cathode of the first voltage stabilizing diode D1 and the input pin (VIN pin) of the voltage stabilizing chip U2. A second end of the sixth capacitor C6 is grounded. A first end of the seventh capacitor C7 is connected between the cathode of the first voltage stabilizing diode D1 and the input pin (VIN pin) of the voltage stabilizing chip U2. A second end of the seventh capacitor C7 is grounded. The second capacitor part 603 includes an eleventh capacitor C11, a ninth capacitor C9, and a tenth capacitor C10. The eleventh capacitor C11, the ninth capacitor C9, and the tenth capacitor C10 are connected in parallel. A first end of the eleventh capacitor C11 is connected between the output pin (VOUT pin) of the voltage stabilizing chip U2 and the fourth pin (VDD pin) of the control module 10. A second end of the eleventh capacitor C11 is grounded. A first end of the ninth capacitor C9 is connected between the output pin (VOUT pin) of the voltage stabilizing chip U2 and the fourth pin (VDD pin) of the control module 10. A second end of the ninth capacitor C9 is grounded. A first end of the tenth capacitor C10 is connected between the output pin (VOUT pin) of the voltage stabilizing chip U2 and the fourth pin (VDD pin) of the control module 10. A second end of the tenth capacitor C10 is grounded.

In this embodiment, the air pressure detection module 300 includes a third plug interface U3. The third plug interface U3 is connected to a differential air pressure sensor 800. The differential air pressure sensor 800 detects the load air volume in real time. A first pin of the third plug interface U3 is connected to a fifth pin of the control module 10. A second pin of the third plug interface U3 is connected to a sixth pin of the control module 10. A third pin of the third plug interface U3 is connected to a seventh pin of the control module 10. A fourth pin of the third plug interface U3 is connected to an eighth pin of the control module 10. The voltage detection module 400 includes a fourth resistor R4, a tenth resistor R10, and a thirteenth capacitor C13. A first end of the fourth resistor R4 is connected between the first pin of the first plug interface CN1 and the anode of the first voltage stabilizing diode D1. A second end of the fourth resistor R4 is connected to the tenth resistor R10 and a ninth pin of the control module 10, respectively. A first end of the tenth resistor R10 is connected to the fourth resistor R4. A second end of the tenth resistor R10 is grounded. A first end of the thirteenth capacitor C13 is connected between the fourth resistor R4 and the ninth pin of the control module 10. A second end of the thirteenth capacitor C13 is grounded.

In this embodiment, the control module 10 includes an MCU 102 and a PWM generation module 900. The MCU 102 receives a start signal. The MCU 102 controls the pulse width modulation PWM generation module 900 to output a PWM signal with a duty cycle starting from a non-zero value and gradually increasing according to a predetermined slope. The PWM signal is amplified by the motor drive module 200 and then drives the motor 500. The first control signal is the PWM signal. A PWM start value calculation formula is: PWM start value=(current air pressure value (unit PSI)*coefficient a)+(maximum supported power supply voltage/current voltage*coefficient b). Coefficient a=1. Coefficient b=50. The unit PSI refers to Pounds per square inch. When the calculated PWM start value is greater than 100, the PWM start value is directly set to 100.

A control method for soft start of the inflation pump includes the following steps.
Step S1 (System Power-on Initialization): The MCU 102 initializes its internal PWM generation module 900 and its internal analog-to-digital conversion module (ADC module) 2000.
Step S2 (Wait for Start Signal): The MCU 102 detects whether a start signal from a switch is received.
Step S3 (Start Soft Start Program): Once the start signal is received, the MCU 102 first acquires a current air pressure value and a power level, combines the current air pressure value and the power level to calculate a start value ‘a’ (to prevent motor stall), and the MCU 102 sets a duty cycle of a PWM output signal to a %.
Step S4 (Ramp Increase PWM Duty Cycle): The MCU 102 linearly increases the duty cycle of the PWM output signal at a slope of increasing 1% duty cycle every 5 milliseconds.
Step S5 (Sampling): Air pressure sampling and voltage sampling are performed and fed back to the MCU 102.
Step S51 (Real-time Air Pressure Sampling): During the increase of the PWM duty cycle, the MCU 102 continuously reads an air pressure value fed back by the air pressure detection module through an ADC pin of the MCU 102 and converts the air pressure value into a real-time air pressure value Q_real.
Step S52 (Real-time Voltage Sampling): During the increase of the PWM duty cycle, the MCU 102 continuously reads a voltage value fed back by the voltage detection module through the ADC pin of the MCU 102 and converts the voltage value into a real-time voltage value V_real.
Step S6 (Judgment and Dynamic Adjustment): The real-time air pressure value Q_real and the real-time voltage value V_real are combined to calculate a new duty cycle b % of the PWM output signal. If b is greater than a current PWM duty cycle, the duty cycle of the PWM output signal is directly set to b %.
Step S7 (Start Completion): When the PWM duty cycle increases to a preset rated operating duty cycle (such as 100%) and the motor current stabilizes near a rated value, the soft start process ends, and the system enters a normal operating state.

In this embodiment, the motor drive module 200 includes a first drive part 201, a second drive part 202, and a third drive part 203. The first drive part 201 receives a power signal from the power input module 600 and a control signal from the control module 10 to form a drive pulse signal, and the drive pulse signal is then fed to the second drive part. The second drive part 202 receives the drive pulse signal from the first drive part 201 and drives the motor 500. The third drive part 203 is an enable control part for the motor 500. The first drive part 201 includes an eleventh field effect transistor Q11 and a twelfth transistor Q12. A source electrode of the eleventh field effect transistor Q11 is connected between the first voltage stabilizing diode D1 and the input pin (VIN pin) of the voltage stabilizing chip U2. A collector electrode of the twelfth transistor Q12 is connected to the source electrode of the eleventh field effect transistor Q11 through a sixty-third resistor R63 and a sixty-fourth resistor R64. A gate electrode of the eleventh field effect transistor Q11 is connected between the sixty-third resistor R63 and the sixty-fourth resistor R64. The first drive part 201 further includes a sixty-sixth resistor R66 and a sixty-fifth resistor R65. A first end of the sixty-sixth resistor R66 is connected to a base electrode of the twelfth transistor Q12. A second end of the sixty-sixth resistor R66 is connected to a tenth pin of the control module 10. An emitter electrode of the twelfth transistor Q12 is grounded. A first end of the sixty-fifth resistor R65 is connected between the sixty-sixth resistor R66 and the base electrode of the twelfth transistor Q12. A second end of the sixty-fifth resistor R65 is connected to the emitter electrode of the twelfth transistor Q12 and is grounded.

In this embodiment, the second drive part 202 includes a ninth chip U9 and a first field effect transistor Q1. A third pin (OUT pin) of the ninth chip U9 is connected to a gate electrode of the first field effect transistor Q1 through a sixty-seventh resistor R67. A drain electrode of the eleventh field effect transistor Q11 is connected to a first pin (VDD pin) of the ninth chip U9. The motor drive module 200 includes a twentieth capacitor C20, a twenty-first capacitor C21, and a first resistor R1. The twentieth capacitor C20 and the twenty-first capacitor C21 are connected in parallel. A first end of the twentieth capacitor C20 is connected to the first pin (VDD pin) of the ninth chip U9. A second end of the twentieth capacitor C20 is connected to a fourth pin of the ninth chip U9 and is grounded. A first end of the twenty-first capacitor C21 is connected between the first pin (VDD pin) of the ninth chip U9 and the twentieth capacitor C20. A second end of the twenty-first capacitor C21 is connected between the fourth pin of the ninth chip U9 and the twentieth capacitor C20 and is grounded. A first end of the first resistor R1 is connected to a fifth pin (IN pin) of the ninth chip U9. A second end of the first resistor R1 is connected to a first pin of the control module 10. The second drive part 202 includes a second plug interface CN2 and a second voltage stabilizing diode D2. A cathode of the second voltage stabilizing diode D2 is connected between the first pin of the first plug interface CN1 and the anode of the first voltage stabilizing diode D1. An anode of the second voltage stabilizing diode D2 is connected to the gate electrode of the first field effect transistor Q1. A first pin of the second plug interface CN2 is connected to the cathode of the second voltage stabilizing diode D2. A second pin of the second plug interface CN2 is connected between the anode of the second voltage stabilizing diode D2 and a drain electrode of the first field effect transistor Q1. The second drive part 202 includes a sixty-eighth resistor R68 and a seventh resistor R7. A first end of the seventh resistor R7 is connected to a source electrode of the first field effect transistor Q1. A second end of the seventh resistor R7 is grounded. A first end of the sixty-eighth resistor R68 is connected between the gate electrode of the first field effect transistor Q1 and the sixty-seventh resistor R67. A second end of the sixty-eighth resistor R68 is grounded.

In this embodiment, the third drive part 203 includes a fifth transistor Q5, a thirteenth resistor R13, and a fifteenth resistor R15. A first end of the thirteenth resistor R13 is connected to a base electrode of the fifth transistor Q5. A second end of the thirteenth resistor R13 is connected to a second pin of the control module 10. A first end of the fifteenth resistor R15 is connected between the thirteenth resistor R13 and the base electrode of the fifth transistor Q5. A second end of the fifteenth resistor R15 is connected to an emitter electrode of the fifth transistor Q5 and is grounded. The emitter electrode of the fifth transistor Q5 is grounded. The third drive part 203 further includes a first motor interface H1, a fifth resistor R5, and a sixth resistor R6. A first pin of the first motor interface H1 is connected between the first pin of the first plug interface CN1 and the anode of the first voltage stabilizing diode D1. A second pin of the first motor interface H1 is connected to the fifth resistor R5 and the sixth resistor R6, respectively. The fifth resistor R5 and the sixth resistor R6 are connected in parallel. A collector electrode of the fifth transistor Q5 is connected to the fifth resistor R5 and the sixth resistor R6, respectively.

In this embodiment, the control module 10 further includes an analog-to-digital conversion module (ADC module) 2000. The analog-to-digital conversion module 2000 receives the load air volume detected in real time by the differential air pressure sensor 800. The analog-to-digital conversion module 2000 converts the load air volume detected in real time by the differential air pressure sensor 800 into a real-time air pressure value by using a filtering algorithm. The analog-to-digital conversion module 2000 receives the voltage detected in real time by the voltage detection module 400. The analog-to-digital conversion module 2000 converts the voltage detected in real time by the voltage detection module 400 into a real-time voltage value by using the filtering algorithm. The filtering algorithm is: y[n]=a0*x[n]+a1*x[n−1] +a2*x[n−2]−b1*y[n−1]−b2*y[n−2], wherein x[n] is an input signal, x[n−1] is a previous input signal, x[n−2] is a second previous input signal, y[n] is an output signal, y[n−1] is a previous output signal, y[n−2] is a second previous output signal, and a0, a1, a2, b1, b2 are coefficients.

The disclosure further provides an inflation pump 100. The inflation pump 100 includes the soft start circuit 1000 as described above.

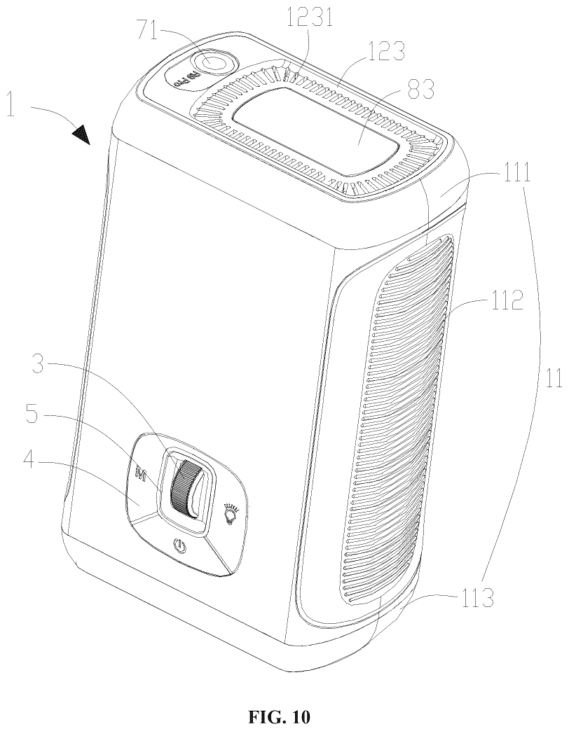

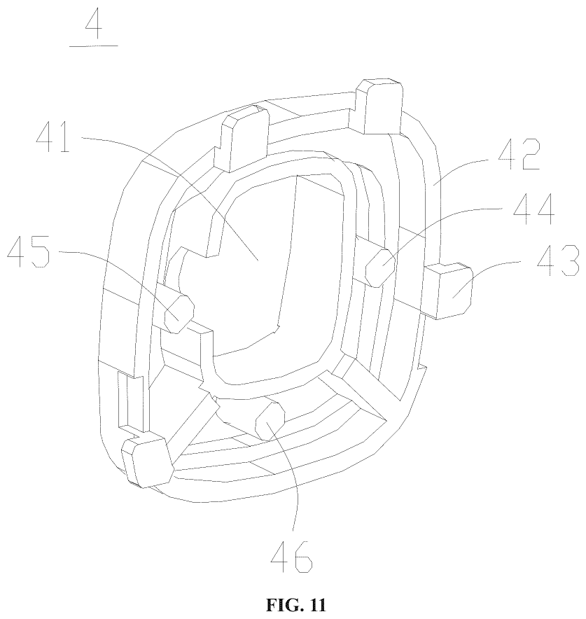

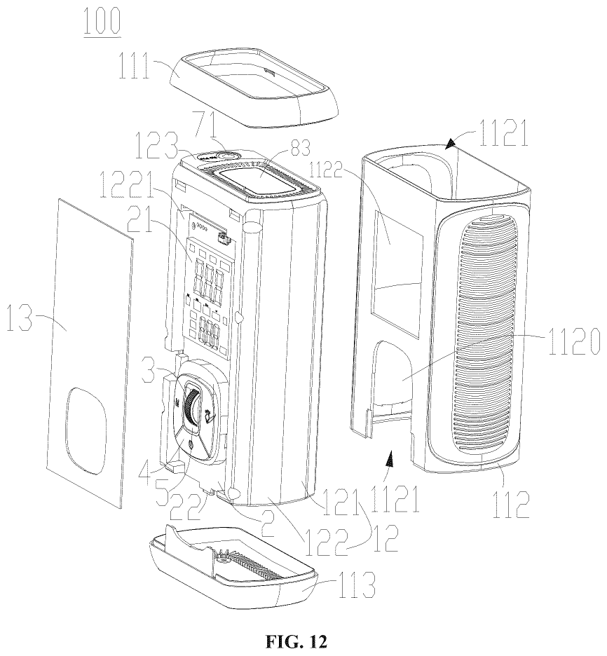

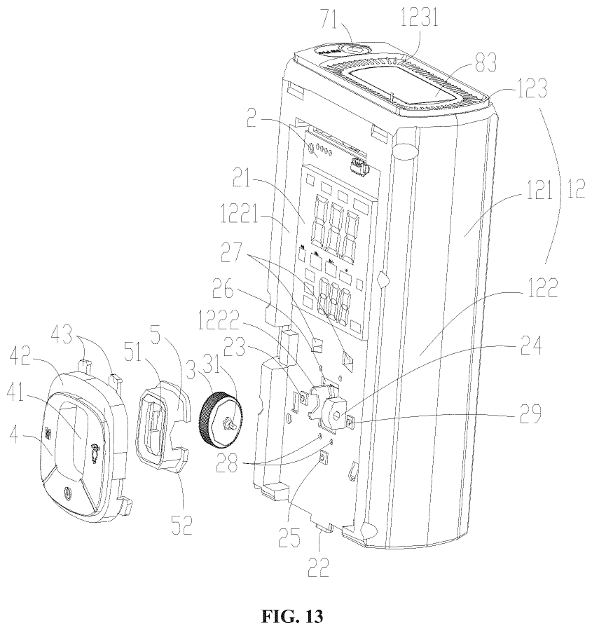

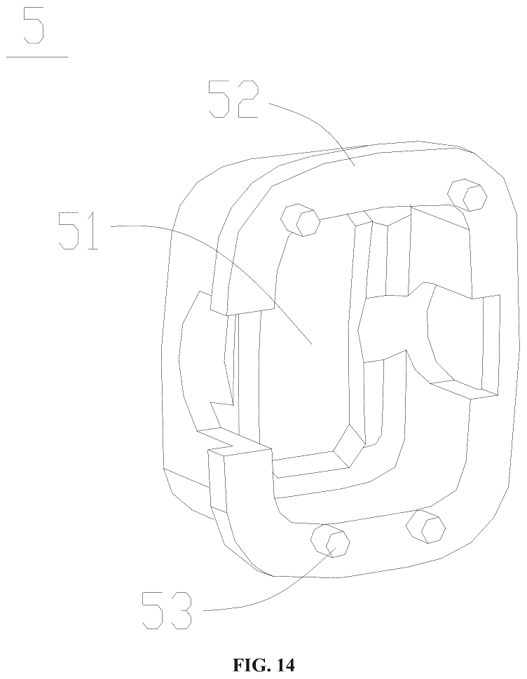

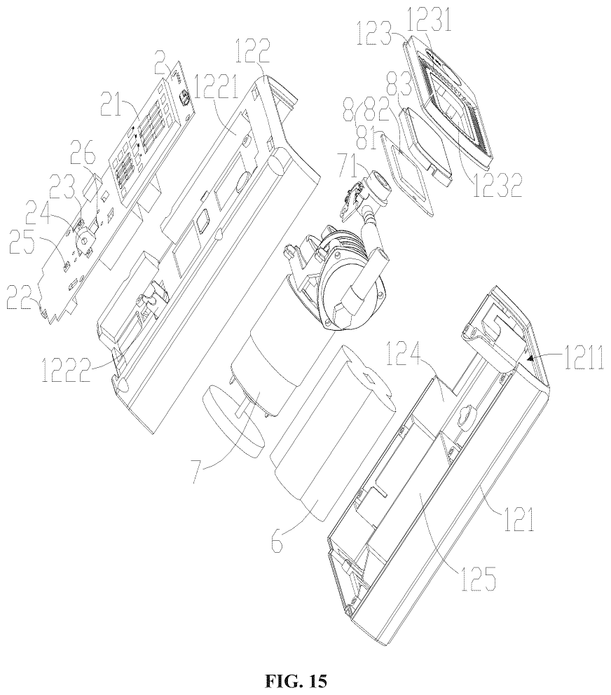

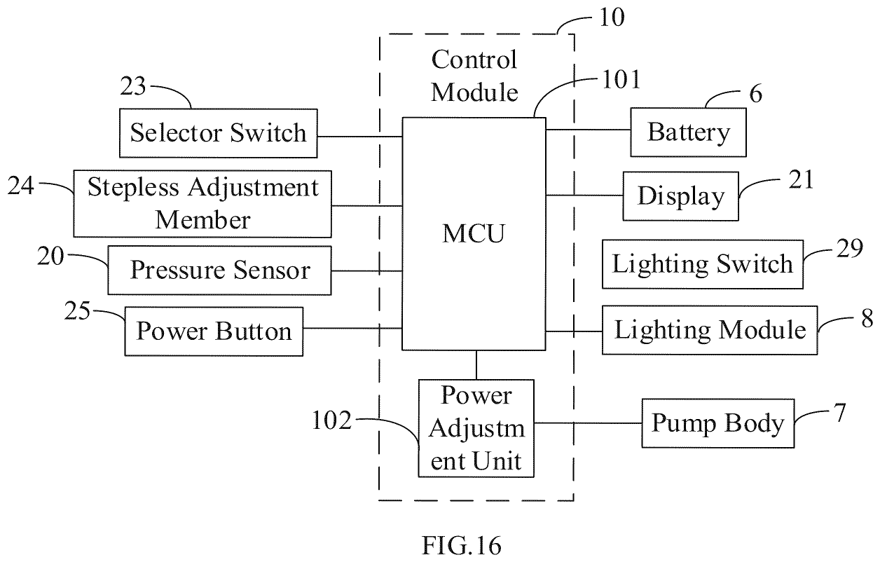

Embodiment 2: With reference to FIG. 10 to FIG. 17, the inflation pump 100 includes a main body 1, a control module 10, a pump body 7, a battery 6, a stepless adjustment member 24, and a selector switch 23. The control module 10, the pump body 7, the battery 6, the stepless adjustment member 24, and the selector switch 23 are arranged on the main body 1. The control module 10 is electrically connected to the battery 6, the pump body 7, the stepless adjustment member 24, and the selector switch 23, respectively. A plurality of inflation types with different power ranges for driving the pump body 7 to work are preset within the control module 10. The selector switch 23 is used for user operation and transmitting a switching signal to the control module 10, and the stepless adjustment member 24 is used for user operation and transmitting a stepless adjustment signal to the control module 10. The control module 10 is configured for switching an inflation type according to the switching signal and outputting preset power corresponding to the inflation type to the pump body 7. The control module 10 is also configured for adjusting driving power output to the pump body 7 within a power range of a corresponding inflation type according to the stepless adjustment signal.

In this embodiment, the plurality of inflation types with different power ranges are configured inside the control module 10, and the selector switch 23 is configured for a user to switch inflation types to adapt to inflation of various types of products. Therefore, the product applicability of the inflation pump 100 can be effectively improved, breaking the limitation of an existing inflation pump that can only inflate one type of product. Furthermore, in this embodiment, by configuring the stepless adjustment member 24, the user can adjust within the power range of the inflation type through the stepless adjustment member 24, allowing the control module 10 to increase or decrease the driving power output to the pump body 7, thereby improving an inflation rate and enhancing the user's experience of using the inflation pump 100.

It should be noted that driving the pump body 7 with different powers can allow the pump body 7 to output different air pressures. Based on this, the control module 10 can configure the power range of driving the pump body 7 according to an air pressure range required to be output by the pump body 7.

Specifically, the plurality of inflation types can be inflating basketballs, inflating car tires, inflating bicycle tires, inflating motorcycle tires, custom inflation, etc. An air pressure range for inflating basketballs can be preset as 4-16 PSI, an air pressure range for inflating bicycle tires can be preset as 30-120 PSI, an air pressure range for inflating motorcycle tires can be preset as 26-44 PSI, an air pressure range for inflating car tires can be preset as 26-51 PSI, and an air pressure range for custom inflation can be preset as 3-150 PSI. Correspondingly, the control module 10 configures a corresponding power range according to an inflation type to drive the pump body 7 to work, so that the pump body 7 outputs a corresponding air pressure.

When the control module 10 switches the inflation type to inflating basketballs, and when the stepless adjustment member 24 is utilized to adjust the output air pressure of the pump body 7, an adjustable air pressure range is limited to 4-16 PSI. Based on factory settings, when the control module 10 switches the inflation type to inflating basketballs and the user provides the inflation pump 100 of this embodiment for inflation, a default output air pressure is 8 PSI when the air pressure is not adjusted by the stepless adjustment member 24.

When the control module 10 switches the inflation type to inflating bicycle tires, and when the stepless adjustment member 24 is utilized to adjust the output air pressure of the pump body 7, the adjustable air pressure range is limited to 30-120 PSI. Based on the factory settings, when the control module 10 switches the inflation type to inflating bicycle tires and the user provides the inflation pump 100 of this embodiment for inflation, the default output air pressure is 45 PSI when the air pressure is not adjusted by the stepless adjustment member 24.

When the control module 10 switches the inflation type to inflating motorcycle tires, and when the stepless adjustment member 24 is utilized to adjust the output air pressure of the pump body 7, the adjustable air pressure range is limited to 26-44PSI. Based on the factory settings, when the control module 10 switches the inflation type to inflating motorcycle tires and the user provides the inflation pump 100 of this embodiment for inflation, the default output air pressure is 35PSI when the air pressure is not adjusted by the stepless adjustment member 24.

When the control module 10 switches the inflation type to inflating car tires, and when the stepless adjustment member 24 is utilized to adjust the output air pressure of the pump body 7, the adjustable air pressure range is limited to 26-51PSI. Based on the factory settings, when the control module 10 switches the inflation type to inflating car tires and the user provides the inflation pump 100 of this embodiment for inflation, the default output air pressure is 36PSI when the air pressure is not adjusted by the stepless adjustment member 24.

When the control module 10 switches the inflation type to custom inflation, and when the stepless adjustment member 24 is utilized to adjust the output air pressure of the pump body 7, the adjustable air pressure range is limited to 3-150 PSI. Based on the factory settings, when the control module 10 switches the inflation type to custom inflation and the user provides the inflation pump 100 of this embodiment for inflation, the default output air pressure is 30 PSI when the air pressure is not adjusted by the stepless adjustment member 24.

Of course, in other embodiments, the pressure range for inflating bicycle tires can also be preset to 20-100 PSI, the pressure range for inflating motorcycle tires can be preset to 20-40 PSI, and the pressure range for inflating car tires can be preset to 20-45 PSI, etc. The air pressure range for inflating bicycle tires, the air pressure range for inflating motorcycle tires, the air pressure range for inflating car tires, and the air pressure range for inflating balls can be customized by manufacturers or in subsequent program upgrades. The air pressures of inflating basketballs, inflating car tires, inflating bicycle tires, inflating motorcycle tires, custom inflation and other inflation types are not limited here.

In an implementation of the present disclosure, the stepless adjustment member 24 can be a digital encoder. Specifically, when a knob of the digital encoder is turned, two changing electrical signals (i.e., stepless adjustment signals) can be output to the control module 10, and the control module 10 adjusts the driving power output to the pump body 7 based on the changing electrical signals.

In an implementation of the present disclosure, the stepless adjustment member 24 can also be a rotary potentiometer, that is, when a knob on the rotary potentiometer is turned, a resistance value of the rotary potentiometer can be adjusted. Based on different resistance values, the rotary potentiometer can feed back different voltage signals (i.e. stepless adjustment signals) to the control module 10, and the control module 10 adjusts the driving power output to the pump body 7 within a power range according to the voltage signal.

Specifically, when the stepless adjustment member 24 can be a digital encoder or a rotary potentiometer, the main body 1 is equipped with a roller 3. The roller 3 is connected to the knob on the digital encoder or the rotary potentiometer. The stepless adjustment member 24 is configured for outputting a stepless adjustment signal to the control module 10 when the user rotates the roller 3. Based on this, the control module 10 adjusts the driving power output to the pump body 7. By using the roller 3, it is convenient for the user to operate.

In an implementation of the present disclosure, the stepless adjustment member 24 can also be a sliding potentiometer. A sliding member is slidably provided on the main body 1. The sliding member is connected to the sliding potentiometer. When the user slides the sliding member, the sliding potentiometer is configured for outputting the stepless adjustment signal to the control module 10. Specifically, when the user slides the sliding member, a resistance value connected to the control module 10 will be changed. Based on different resistance values, the rotary potentiometer can feed back different voltage signals (i.e. stepless adjustment signals) to the control module 10. The control module 10 adjusts the driving power output to the pump body 7 within the power range according to the voltage signals.

In the above embodiment, the control module 10 includes an MCU 101 and a power adjustment unit 102. The selector switch 23, the stepless adjustment member 24, the battery 6, and the power adjustment unit 102 are all electrically connected to the MCU 101. The power adjustment unit 102 is electrically connected to the pump body 7. The plurality of inflation types are provided in the MCU 101. The MCU 101 is used for receiving the stepless adjustment signal and generating a driving signal corresponding to the stepless adjustment signal. The power adjustment unit 102 is used for receiving the driving signal and adjusting the driving power output to the pump body 7 to achieve the output of driving power corresponding to an inflation type to the pump body 7.

Specifically, the power adjustment unit 102 includes a switch tube 1021. A drain electrode of the switch tube 1021 is electrically connected to a negative electrode of the pump body 7. A source electrode of the switch tube 1021 is grounded. A grid electrode of the switch tube 1021 is electrically connected to the MCU 101. A positive electrode of the battery 6 is electrically connected to a positive electrode of the pump body 7. The switch tube 1021 conducts according to the driving signal output by the MCU 101 and adjusts duty ratio according to the driving signal to regulate the driving power output to the pump body 7. By utilizing the conduction duty cycle of the switch tube 1021, a voltage output to the pump body 7 can be adjusted, thereby achieving the adjustment of the power output to the pump body 7.

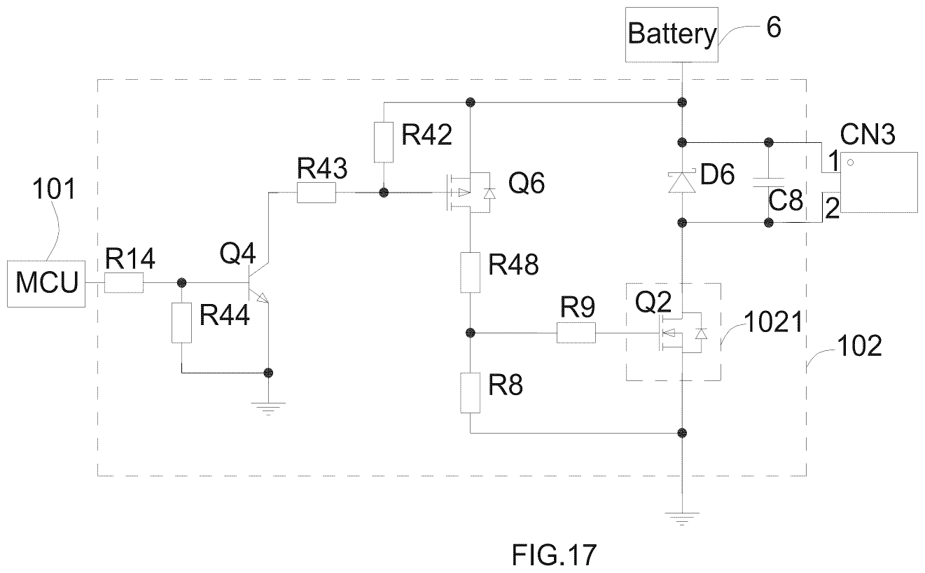

Of course, in other embodiments, the power adjustment unit 102 may also include a plurality of switch tubes 1021, resistors, and other components, as shown in FIG. 17, a CN3 interface is used for connecting to the pump body 7.

In an implementation of the present disclosure, the inflation pump 100 further includes a pressure sensor 20 arranged on the main body 1. The pressure sensor 20 is positioned at an output end of the pump body 7. The pressure sensor 20 is electrically connected to the control module 10, that is, the pressure sensor 20 is electrically connected to the MCU 101. The pressure sensor 20 is used for detecting an air pressure output by the main body and feeding back a pressure signal corresponding to the air pressure to the control module 10. The control module 10 adjusts the driving power output to the pump body 7 based on the pressure signal. The pressure sensor 20 is used for detecting the air pressure output by the pump body 7 in real time, and feeding back an electrical signal corresponding to the air pressure to the MCU 101. Based on the electrical signal, the MCU 101 outputs driving power to the pump body 7 to allow the pump body 7 to output air pressure at a constant rate, stabilizing the output air pressure at a value.

In an implementation of the present disclosure, the inflation pump 100 further includes a display 21 arranged on the main body 1. The display 21 is used for at least one of displaying the output air pressure and displaying electrical quantity of the battery 6. Through the display 21, the user can understand the electrical quantity of the battery 6 and the output air pressure, making it convenient for the user to use. Specifically, the display 21 can be a digital display 21 or a display screen, etc.

In an implementation of the present disclosure, the inflation pump 100 further includes a lighting module 8 for illumination. The lighting module 8 is arranged on the main body 1, and the control module 10 is electrically connected to the lighting module 8. By means of the lighting module 8, the inflation pump 100 of this embodiment can have a lighting function, which can be used when needed by the user and improve the practicality of the inflation pump 100 of this embodiment.

Specifically, the lighting module 8 includes a lamp board 81 arranged inside the main body 1 and a lighting lamp 82 arranged on the lamp board 81. The lamp board 81 is electrically connected to the control module 10, and the lamp board 81 is positioned at a top portion of the pump body 7. A top portion of the main body 1 is provided with a lighting opening 1232 at a position corresponding to the lighting lamp 82. The main body 1 is provided with a lampshade 83 at a position corresponding to the lighting opening 1232. The top portion of the main body 1 is provided with an air outlet interface 71 for connecting to an inflation tube. The air outlet interface 71 is in communication with an air outlet of the pump body 7. The air outlet interface 71 is positioned on one side of the lighting opening 1232 to reasonably configure the structure of the inflation pump 100 in this embodiment. When the pump body 7 outputs air pressure through the air outlet interface 71, the lighting module 8 will not be damaged.

In an implementation of the present disclosure, the main body 1 is provided with a plurality of air inlet holes 1231 on a periphery of the lampshade 83. The air outlet interface 71 is positioned on one side of the air inlet holes 1231 away from the lighting opening 1232. By using the air inlet holes 1231, air can enter the pump body 7 from the outside and be processed to form gas with a certain air pressure, and then the gas is output through the air outlet interface 71. Moreover, by using the air inlet hole 1231, the lamp board 81 can also dissipate heat.

In the above embodiment, the inflation pump 100 further includes a lighting switch 29, and the control module 10 drives the lighting module 8 to illuminate when the lighting switch 29 is operated, so that the user can control the lighting to be turned on for use through the lighting switch 29 when lighting is needed.

In an implementation of the present disclosure, the main body 1 is equipped with a charging interface 22 for connecting to an external power supply. The charging interface 22 is electrically connected to the control module 10. By connecting the charging interface 22 to the external power supply, the battery 6 can be charged through the control module 10.

Specifically, the control module 10 also includes a charging and discharging circuit. The charging and discharging circuit is electrically connected to the charging interface 22, the battery 6, the MCU 101, and the power adjustment unit 102. After the charging interface 22 is connected to the power supply, the battery 6 is charged through the charging and discharging circuit. In this embodiment, when the charging pump 100 is used, the battery 6 can supply power to the MCU 101 and the power adjustment unit 102 through the charging and discharging circuit. In an embodiment with a lighting module 8, the charging and discharging circuit is also electrically connected to the lighting module 8 to supply power to the lighting module 8. Alternatively, in a state where the MCU 101 can directly drive the lighting module 8, the charging and discharging circuit may not be electrically connected to the lighting module 8.

In the above embodiment, the inflation pump 100 further includes a circuit board 2. The control module 10, the stepless adjustment member 24, and the selector switch 23 are all integrated on the circuit board 2. The circuit board 2 is provided inside the main body 1 to simplify parts of the inflation pump 100 in this embodiment and facilitate the production and manufacturing of the inflation pump 100.

In an implementation of the present disclosure, the main body 1 includes a middle housing 12 and an outer cover 11. A first cavity 124 and a second cavity 125 are defined in the middle housing. The pump body 7 is arranged in the first cavity 124, and the battery 6 is arranged in the second cavity 125. The outer cover 11 is sleeved on an outer side of the middle housing 12. A third cavity 1221 is formed between the outer cover 11 and the middle housing 12. The circuit board 2 is arranged in the third cavity 1221. The third cavity 1221 is respectively connected to the first cavity 124 and the second cavity 125, so that the control module 10 is electrically connected to the pump body 7 and the battery 6. Moreover, the first cavity 124, the second cavity 125, and the third chamber 1221 are respectively equipped with the pump body 7, the battery 6, and the circuit board 2, so that the pump body 7, the battery 6, and the circuit board 2 can be installed on the main body 1, and the compactness of the structure of the inflation pump 100 in this embodiment can also be improved.

In an embodiment where the stepless adjustment member 24 is a digital encoder and is connected to the roller 3, shaft rods 31 are provided on both sides of the roller 3, and one of the shaft rods 31 is connected to the digital encoder. The stepless adjustment member 24 and the selector switch 23 are both positioned on a surface of the circuit board 2 away from the first cavity 124, and the selector switch 23 is positioned next to the stepless adjustment member 24. By disposing the stepless adjustment member 24 and the selector switch 23 together, it is easy for the user to operate and use.

The middle housing 12 is equipped with a support block 1222 at a position corresponding to the shaft rod 31, and the circuit board 2 is provided with a first avoidance opening 26 for avoiding the support block 1222. The inflation pump 100 further includes a position limiting cover 5 and a pressing member 4. The position limiting cover 5 is sleeved on an outer side of the roller 3 and cooperates with the support block 1222 to limit a position of the roller 3. The position limiting cover 5 is provided with a second avoidance opening 51 for avoiding the roller 3. By using the first avoidance opening 26, the support block 1222 can pass through the circuit board 2, so that the support block 1222 can cooperate with the position limiting cover 5 to achieve position limiting of the shaft rods 31 on both sides of the roller 3, thereby limiting the position of the roller 3. Moreover, by using the second avoidance opening 51, the roller 3 can be exposed for user operation.

The pressing member 4 is made of flexible material, and the pressing member 4 is sleeved on an outer side of the position limiting cover 5. The pressing member 4 is provided with a third avoidance opening 41 for avoiding the position limiting cover 5, so as to expose the roller 3. A first position limiting edge 52 is provided on a periphery of the position limiting cover 5, and a second position limiting edge 42 is provided on a periphery of the pressing member 4 in a protruding manner. The first position limiting edge 52 is positioned between the pressing member 4 and the circuit board 2, and the second position limiting edge 42 is positioned between the circuit board 2 and the outer cover 11 to achieve the fixation of the position limiting cover 5 and the pressing member 4.

The pressing member 4 is equipped with a first pressing rod 44 at a position corresponding to the selector switch 23 for pressing the selector switch 23. The outer cover 11 is provided with a fourth avoidance opening 1120 for avoiding the pressing member 4, so that the user can press the pressing member 4. Moreover, when the user presses the pressing member 4 at the first pressing rod 44, by using the first pressing rod 44, the selector switch 23 can be pressed, so that the selector switch 23 can be made conductive, that is, the selector switch 23 feeds back an electrical signal (i.e. switching signal) to the control module 10, and the control module 10 switches the inflation type according to the signal.

In an implementation of the present disclosure, the position limiting cover 5 is provided with first positioning ends 53, and the pressing member 4 is provided with second positioning ends 43. First positioning holes 28 and second positioning holes 27 are defined in the circuit board 2. The first positioning end 53 is placed inside the first positioning hole 28, and the second positioning end 43 is placed inside the second positioning hole 27, thereby improving the stability of the installation of the position limiting cover 5 and the pressing member 4.

In an implementation of the present disclosure, the circuit board 2 is also provided with a power button 25 electrically connected to the control module 10. The power button 25 and the selector switch 23 are arranged around a periphery of the roller 3. The pressing member 4 is provided with a second pressing rod 46 at a position corresponding to the power button 25 for pressing the power button 25. When the user presses the pressing member 4 at the second pressing rod 46, by using the second pressing rod 46, the power button 25 can be pressed, so that the power button 25 can be made conductive. That is, the power button 25 feeds back an electrical signal to the control module 10, and the control module 10 activates or inactivates according to the signal, so that the user can operate the selector switch 23 and the stepless adjustment member 24 later.

In an embodiment with a lighting module 8, the inflation pump 100 further includes the lighting module 8 for illumination. The circuit board 2 is provided with a lighting switch 29 electrically connected to the control module 10. The lighting switch 29 and the selector switch 23 are arranged around the periphery of the roller 3. The pressing member 4 is provided with a third pressing rod 45 at a position corresponding to the lighting switch 29 for pressing the lighting switch 29. When the user presses the pressing member 4 at the third pressing rod 45, by using the third pressing rod 45, the lighting switch 29 can be pressed, so that the lighting switch 29 can be conductive, that is, the lighting switch 29 feeds back an electrical signal to the control module 10, and the control module 10 drives the lighting module 8 to illuminate or turn off the lighting module 8 according to the signal.

In an implementation of the present disclosure, the middle housing 12 includes a first housing 121 and a second housing 122. The second housing 122 is connected to the first housing 121 to form the first cavity 124 and the second cavity 125. The middle housing 12 is formed by connecting the first housing 121 to the second housing 122, which facilitates the manufacturing and production of the middle housing 12. Moreover, the first housing 121 and the second housing 122 can be fixed by screws, buckles, glue, and other methods.

A top portion of the first cavity 124 is a top opening 1211, and the middle housing 12 further includes a top cover plate 123 arranged at the top opening 1211. The lighting module 8 is positioned inside the first cavity 124, and the lamp board 81 of the lighting module 8 is arranged on the top cover plate 123. A lighting opening 1232 is defined in the top cover plate 123, and the lampshade 83 is arranged at the lighting opening 1232 of the top cover plate 123 to allow the light of the lighting module 8 to pass through. The lampshade 83 is limited and fixed by the lamp board 81 and the top cover plate 123.

In an implementation of the present disclosure, the outer cover 11 includes: a kit 112 with fifth avoidance openings 1121 at both ends, a top housing 111 sleeved on a top portion of the middle housing 12, and a bottom housing 113 sleeved on a bottom portion of the middle housing 12. By using the kit 112 with the fifth avoidance openings 1121 on both ends, the kit 112 can be sleeved on a middle position of the middle housing 12. The kit 112 is sleeved on the middle housing 12 and forms the third cavity 1221 with the middle housing 12. The top housing 111 and the bottom housing 113 are respectively positioned at an upper end and a lower end of the kit 112, and the top housing 111 and the bottom housing 113 cooperate to fix the kit 112 to prevent the kit 112 from moving. Moreover, the top housing 111 is sleeved on the middle housing 12, which can also press the top cover plate 123 tightly. Specifically, both the top housing 111 and the bottom housing 113 can be fixed to the middle housing 12 using screws or buckles, etc.

The circuit board 2 is equipped with a display 21, and the outer cover 11 is provided with a display window 1122 at a position corresponding to the display 21. The kit 112 is equipped with a light-transmitting cover plate 13 at a position corresponding to the display window 1122, and the light-transmitting cover plate 13 can be used for protecting the display 21.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A soft start circuit for an inflation pump motor, comprising:
a control module, a motor drive module, an air pressure detection module, and a voltage detection module,
wherein the control module is connected to the motor drive module, the air pressure detection module, and the voltage detection module, respectively;
wherein the control module is configured to output a first control signal to the motor drive module, and the motor drive module is configured to drive a motor;
wherein the air pressure detection module is configured to detect a load air volume in real time and feed back the load air volume to the control module, and the voltage detection module is configured to detect a voltage in real time and feed back the voltage to the control module; and
wherein the control module is configured to dynamically adjust a duty cycle of the first control signal according to an air pressure value fed back by the air pressure detection module and a voltage value fed back by the voltage detection module, so as to increase a current of the motor to a rated operating current.

2. The soft start circuit according to claim 1, further comprising a power input module; wherein an external power supply is input to the control module through the power input module; the power input module comprises a first plug interface; the external power supply is connected to the first plug interface; the first plug interface is configured for charging or direct power supply; a first pin of the first plug interface is connected to an anode of the external power supply, and a second pin of the first plug interface is connected to a cathode of the external power supply.

3. The soft start circuit according to claim 2, wherein the power input module further comprises a voltage stabilizing circuit configured to stabilize an input voltage of the power input module to 3.3V and supply power to the control module; the voltage stabilizing circuit comprises a first voltage stabilizing diode and a voltage stabilizing chip; an anode of the first voltage stabilizing diode is connected to the first pin of the first plug interface, and a cathode of the first voltage stabilizing diode is connected to an input pin of the voltage stabilizing chip; an output pin of the voltage stabilizing chip is connected to a fourth pin of the control module, and the fourth pin of the control module is connected to a first capacitor and is grounded; the external power supply is configured to output an initial voltage to the voltage stabilizing chip, and the voltage stabilizing chip is configured to stabilize the initial voltage and output the stabilized voltage to the control module.

4. The soft start circuit according to claim 3, wherein the power input module further comprises a first capacitor part and a second capacitor part, both configured to filter and decouple the input voltage of the power input module; the first capacitor part comprises a fifth capacitor, a sixth capacitor, and a seventh capacitor; the fifth capacitor, the sixth capacitor and the seventh capacitor are connected in parallel; a first end of the fifth capacitor is connected between the cathode of the first voltage stabilizing diode and the input pin of the voltage stabilizing chip, and a second end of the fifth capacitor is grounded; a first end of the sixth capacitor is connected between the cathode of the first voltage stabilizing diode and the input pin of the voltage stabilizing chip, and a second end of the sixth capacitor is grounded; a first end of the seventh capacitor is connected between the cathode of the first voltage stabilizing diode and the input pin of the voltage stabilizing chip, and a second end of the seventh capacitor is grounded.

5. The soft start circuit according to claim 4, wherein the second capacitor part comprises an eleventh capacitor, a ninth capacitor, and a tenth capacitor; the eleventh capacitor, the ninth capacitor, and the tenth capacitor are connected in parallel; a first end of the eleventh capacitor is connected between the output pin of the voltage stabilizing chip and the fourth pin of the control module, and a second end of the eleventh capacitor is grounded; a first end of the ninth capacitor is connected between the output pin of the voltage stabilizing chip and the fourth pin of the control module, and a second end of the ninth capacitor is grounded; a first end of the tenth capacitor is connected between the output pin of the voltage stabilizing chip and the fourth pin of the control module, and a second end of the tenth capacitor is grounded.

6. The soft start circuit according to claim 1, wherein the air pressure detection module comprises a third plug interface connected to a differential air pressure sensor, and the differential air pressure sensor is configured to detect the load air volume in real time.

7. The soft start circuit according to claim 6, wherein a first pin of the third plug interface is connected to a fifth pin of the control module, a second pin of the third plug interface is connected to a sixth pin of the control module, a third pin of the third plug interface is connected to a seventh pin of the control module, and a fourth pin of the third plug interface is connected to an eighth pin of the control module.

8. The soft start circuit according to claim 1, wherein the voltage detection module comprises a fourth resistor, a tenth resistor, and a thirteenth capacitor; a first end of the fourth resistor is connected between the first pin of the first plug interface and the anode of the first voltage stabilizing diode, and a second end of the fourth resistor is connected to the tenth resistor and a ninth pin of the control module respectively; a first end of the tenth resistor is connected to the fourth resistor, and a second end of the tenth resistor is grounded; a first end of the thirteenth capacitor is connected between the fourth resistor and the ninth pin of the control module, and a second end of the thirteenth capacitor is grounded.

9. The soft start circuit according to claim 1, wherein the control module comprises an MCU and a PWM generation module; the MCU is configured to receive a start signal and control the PWM generation module to output a PWM signal with a duty cycle starting from a non-zero value and gradually increasing according to a predetermined slope; the PWM signal is amplified by the motor drive module and then drives the motor; the first control signal is the PWM signal.

10. The soft start circuit according to claim 3, wherein the motor drive module comprises a first drive part, a second drive part, and a third drive part; the first drive part is configured to receive a power signal from the power input module and a control signal from the control module to form a drive pulse signal, and the drive pulse signal is then fed to the second drive part; the second drive part is configured to receive the drive pulse signal from the first drive part and drive the motor; the third drive part is an enable control part for the motor.

11. The soft start circuit according to claim 10, wherein the first drive part comprises an eleventh field effect transistor and a twelfth transistor; a source electrode of the eleventh field effect transistor is connected between the first voltage stabilizing diode and the input pin of the voltage stabilizing chip; a collector electrode of the twelfth transistor is connected to the source electrode of the eleventh field effect transistor through a sixty-third resistor and a sixty-fourth resistor, and a gate electrode of the eleventh field effect transistor is connected between the sixty-third resistor and the sixty-fourth resistor.

12. The soft start circuit according to claim 11, wherein the first drive part further comprises a sixty-sixth capacitor and a sixty-fifth capacitor; a first end of the sixty-sixth capacitor is connected to a base electrode of the twelfth transistor, and a second end of the sixty-sixth capacitor is connected to a tenth pin of the control module; an emitter electrode of the twelfth transistor is grounded; a first end of the sixty-fifth capacitor is connected between the sixty-sixth capacitor and the base electrode of the twelfth transistor, and a second end of the sixty-fifth capacitor is connected to the emitter electrode of the twelfth transistor and is grounded.

13. The soft start circuit according to claim 11, wherein the second drive part comprises a ninth chip, a first field effect transistor, a twentieth capacitor, a twenty-first capacitor and a first resistor; a third pin of the ninth chip is connected to a gate electrode of the first field effect transistor through a sixty-seventh resistor; a drain electrode of the eleventh field effect transistor is connected to a first pin of the ninth chip; the twentieth capacitor and the twenty-first capacitor are connected in parallel; a first end of the twentieth capacitor is connected to the first pin of the ninth chip, and a second end of the twentieth capacitor is connected to a fourth pin of the ninth chip and is grounded; a first end of the twenty-first capacitor is connected between the first pin of the ninth chip and the twentieth capacitor, and a second end of the twenty-first capacitor is connected between the fourth pin of the ninth chip and the twentieth capacitor and is grounded; a first end of the first resistor is connected to a fifth pin of the ninth chip, and a second end of the first resistor is connected to a first pin of the control module.

14. The soft start circuit according to claim 13, wherein the second drive part further comprises a second plug interface and a second voltage stabilizing diode; a cathode of the second voltage stabilizing diode is connected between the first pin of the first plug interface and the anode of the first voltage stabilizing diode; an anode of the second voltage stabilizing diode is connected to the gate electrode of the first field effect transistor; a first pin of the second plug interface is connected to the cathode of the second voltage stabilizing diode, and a second pin of the second plug interface is connected between the anode of the second voltage stabilizing diode and a drain electrode of the first field effect transistor.

15. The soft start circuit according to claim 13, wherein the second drive part further comprises a sixty-eighth resistor and a seventh resistor; a first end of the seventh resistor is connected to a source electrode of the first field effect transistor, and a second end of the seventh resistor is grounded; a first end of the sixty-eighth resistor is connected between the gate electrode of the first field effect transistor and the sixty-seventh resistor, and a second end of the sixty-eighth resistor is grounded.

16. The soft start circuit according to claim 10, wherein the third drive part comprises a fifth transistor, a thirteenth resistor, and a fifteenth resistor; a first end of the thirteenth resistor is connected to a base electrode of the fifth transistor, and a second end of the thirteenth resistor is connected to a second pin of the control module; a first end of the fifteenth resistor is connected between the thirteenth resistor and the base electrode of the fifth transistor, and a second end of the fifteenth resistor is connected to an emitter electrode of the fifth transistor and is grounded; the emitter electrode of the fifth transistor is grounded.

17. The soft start circuit according to claim 16, wherein the third drive part further comprises a first motor interface, a fifth resistor, and a sixth resistor; a first pin of the first motor interface is connected between the first pin of the first plug interface and the anode of the first voltage stabilizing diode, and a second pin of the first motor interface is connected to the fifth resistor and the sixth resistor respectively; the fifth resistor and the sixth resistor are connected in parallel; a collector electrode of the fifth transistor is connected to the fifth resistor and the sixth resistor respectively.

18. The soft start circuit according to claim 6, wherein the control module further comprises an analog-to-digital conversion module; the analog-to-digital conversion module is configured to receive the load air volume detected in real time by the differential air pressure sensor and convert the load air volume into a real-time air pressure value by using a filtering algorithm; the analog-to-digital conversion module is configured to receive a voltage detected in real time by the voltage detection module and convert the voltage into a real-time voltage value by using the filtering algorithm.

19. An inflation pump, comprising the soft start circuit according to claim 1.

20. The inflation pump according to claim 19, further comprising a main body provided with a control module, a pump body, a battery, a stepless adjustment member, and a selector switch; wherein the control module is electrically connected to the battery, the pump body, the stepless adjustment member, and the selector switch, respectively;
a plurality of inflation types with different power ranges for driving the pump body to work are preset within the control module; the selector switch is configured to be operated by a user and to transmit a switching signal to the control module; the stepless adjustment member is configured to be operated by a user and to transmit a stepless adjustment signal to the control module;
the control module is configured for switching an inflation type according to the switching signal and outputting preset power corresponding to the inflation type to the pump body, and the control module is further configured for adjusting driving power output to the pump body within a power range of a corresponding inflation type according to the stepless adjustment signal.
